(19) United States
(12) Patent Application Publication
(10) Pub. No.: US 2025/0123774 A1
(43) Pub. Date: Apr. 17, 2025

(54) COMPUTING SYSTEM FOR PROCESSING COMMAND AND METHOD OF OPERATING THE SAME

(71) Applicant: SK hynix Inc., Icheon-si (KR)

(72) Inventor: Kyu Ho CHOI, Icheon-si (KR)

(21) Appl. No.: 18/617,591

(22) Filed: Mar. 26, 2024

(30) Foreign Application Priority Data
Oct. 17, 2023 (KR) 10-2023-0138381

(51) Int. Cl. G06F 3/06

(52) U.S. Cl. CPC G06F 3/0659; G06F 3/0604; G06F 3/0673

(57) ABSTRACT

Provided herein may be a computing system having improved command processing speed. The computing system may include a host device configured to generate a command including information associated with operations to be requested, the information including a first information portion associated with a first operation of the operations and a second information portion associated with a second operation to be requested subsequent to the first operation, and output the command including the first information portion and the second information portion, and a storage device configured to store data and in communication with the host device, wherein the storage device is configured to: receive the command from the host device, perform the first operation in response to the command, and perform part of the second operation based on the second information portion in the command.

### CROSS-REFERENCE TO RELATED APPLICATION

This patent document claims priority to and benefits of the Korean patent application number 10-2023-0138381, filed on Oct. 17, 2023, which is incorporated herein by reference in its entirety.

### TECHNICAL FIELD

Various embodiments of the disclosed technology generally relate to a semiconductor device, and more particularly to a computing system for processing a command and a method of operating the computing system.

### BACKGROUND

A storage device may be any type of computing hardware that is used for storing or extracting data files and objects. The storage device can operate under the control of another device such as a host device. The storage device may include a memory device that stores data, a buffer memory that temporarily stores data, and a memory controller that controls the memory device and the buffer memory.

### SUMMARY

Various embodiments of the disclosed technology relate to a computing system that is capable of reducing a command processing time and a method of operating the computing system.

In an embodiment of the disclosed technology, a computing system may include a host device configured to generate a command including information associated with operations to be requested, the information including a first information portion associated with a first operation of the operations and a second information portion associated with a second operation to be requested subsequent to the first operation, and output the command including the first information portion and the second information portion, and a storage device configured to store data and in communication with the host device, wherein the storage device is configured to: receive the command from the host device, perform the first operation in response to the command, and perform part of the second operation based on the second information portion in the command.

In an embodiment of the disclosed technology, a method of operating a computing system may include generating, by a host device, a first command including information associated with operations to be requested, the information including a first information portion associated with a first operation and a second information portion associated with a second operation to be requested subsequent to the first operation, transmitting, by the host device, the first command to a storage device that stores data, performing, by the storage device, the first operation in response to the first command, performing, by the storage device, part of the second operation based on the second information portion in response to the first command, transmitting, by the storage device, a response to the first command to the host device, generating, by the host device, a second command including the second information portion, transmitting, by the host device, the second command to the storage device, and performing, by the storage device, a remaining operation other than the part of the second operation in response to the second command.

In an embodiment of the disclosed technology, a computing system may include a host device configured to: insert a plurality of second information portions associated with a plurality of second operations into a command for requesting a first operation, and output the command including the plurality of second information portions, and a storage device coupled in communication with the host device and configured to: receive the command from the host device, perform the first operation in response to the command, and perform respective parts of the plurality of second operations based on the plurality of second information portions in the command.

### BRIEF DESCRIPTION OF THE DRAWINGS

FIG. 1 is a diagram illustrating a computing system based on an embodiment of the disclosed technology.

FIG. 2 is a diagram illustrating a command that is transmitted and received between a host device and a storage device based on an embodiment of the disclosed technology.

FIG. 3 is a diagram illustrating an extra header segment based on an embodiment of the disclosed technology.

FIG. 4 is a flow diagram illustrating an example of performing part of a second operation to be requested after performing a first operation based on an embodiment of the disclosed technology.

FIGS. 5A and 5B are diagrams illustrating an example of performing a read operation to be requested after performing a first operation based on an embodiment of the disclosed technology.

FIGS. 6A and 6B are diagrams illustrating an example of performing a write operation to be requested after performing a first operation based on an embodiment of the disclosed technology.

FIG. 7 is a diagram illustrating an example of providing error information to a host device based on an embodiment of the disclosed technology.

FIG. 8 is a flow diagram illustrating an example of performing part of each of a plurality of operations to be requested after performing a first operation based on an embodiment of the disclosed technology.

FIG. 9 is a flowchart illustrating a method of operating a computing system based on an embodiment of the disclosed technology.

### DETAILED DESCRIPTION

Specific structural features or functions for certain embodiments disclosed in this patent document are examples to describe certain implementations of the disclosed technology.

A host devices and a storage device can communicate using a data packet called a protocol information unit (PIU). A protocol information unit may be a type of data packet generated according to a predefined standard. The protocol information unit may include a basic header segment, transaction specific fields, and an extra header segment (EHS). The host device and the storage device may transmit data by including the data in the extra header segment of the protocol information unit.

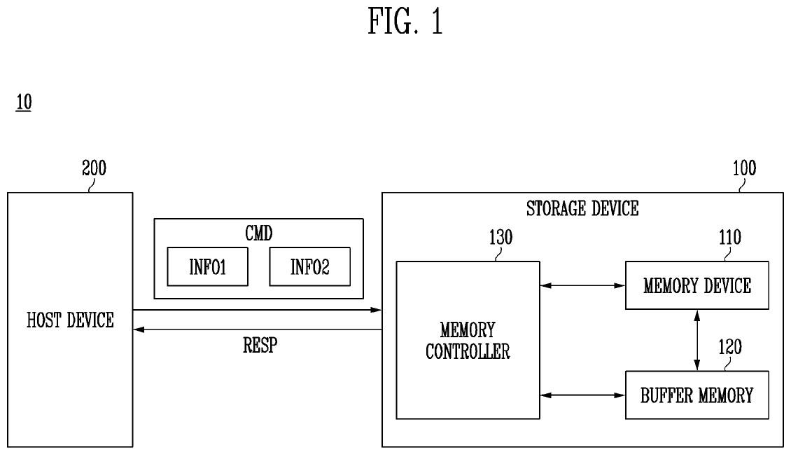

FIG. 1 is a diagram illustrating a computing system based on an embodiment of the disclosed technology.

Referring to FIG. 1, a computing system 10 may include a storage device 100 that stores data and a host device 200 in communication with the storage device 100 to access data stored in the storage device. The host device 200 may include one or more processors to perform operations and to write data to or to receive data from the storage device 100. In some implementations, the host device 200 may be in various device configurations, including a cellular phone, an MP3 player, a laptop computer, a desktop computer, a game machine, a TV, an in-vehicle infotainment system, etc. In an embodiment, the computing system 10 may be an electronic system configured to process various types of information, such as a mobile phone, a smart phone, an MP3 player, a laptop computer, a server computer, a desktop computer, a TV, a tablet PC, or an in-vehicle infotainment system.

In some implementations, the storage device 100 may store data under the control of the host device 200.

The storage device 100 may include a memory device 110, a buffer memory 120, and a memory controller 130, which controls the operation of the memory device 110 and the buffer memory 120.

The storage device 100 may be implemented as any one of various storage devices, such as a solid state drive (SSD), an MMC or eMMC type-multimedia card, a universal serial bus (USB) storage device, a universal flash storage (UFS) device, a peripheral component interconnection (PCI) or PCI express (PCI-E) card-type storage device, a compact flash (CF) card, a smart media card, and a memory stick, depending on a communication method between the storage device 100 and the host device 200. In some embodiments discussed in this patent document, the memory device 110 is a UFS device.

The storage device 100 may be manufactured in any one of various types of package forms. For example, the storage device 100 may be manufactured in any one of various types of package forms, such as package on package (POP), system in package (SIP), system on chip (SOC), multi-chip package (MCP), chip on board (COB), wafer-level fabricated package (WFP), and wafer-level stack package (WSP).

The memory device 110 may store data. The memory device 110 may include a plurality of memory blocks which store data. Each memory block may include a plurality of memory cells.

In an embodiment, the memory device 110 may include a plurality of zones. Each zone, which is a sequential area, may be a storage area in which pieces of data corresponding to successive addresses input from the host device 200 are stored. Each of the plurality of zones may include a plurality of memory blocks. In an embodiment, the numbers of memory blocks respectively included in the plurality of zones may be different from each other or identical to each other. Each zone may be a storage area corresponding to a logical address group composed of logical addresses input from the host device. Here, each of logical address groups may include successive logical addresses.

In an embodiment, the memory device 110 may be a nonvolatile memory in which data is retained even when power is interrupted. In some embodiments discussed in this patent document, the memory device 110 is a NAND flash memory.

In an embodiment, the memory device 110 may receive an internal command and an address from the memory controller 130. The internal command may be a command generated by the memory controller 130 to control the operation of the memory device 110 and the buffer memory 120. The memory device 110 may perform an operation indicated by the internal command for an area selected by the address. For example, the memory device 110 may perform a write operation (or a program operation), a read operation, and an erase operation.

In an embodiment, the memory device 110 may store a map table including mapping relationships between logical addresses, provided from the host device 200, and physical addresses. The map table may further include write pointer location information indicating the logical address of data to be stored in each zone. In some implementations, a portion of the map table may be loaded into the buffer memory 120 or a memory included in the memory controller 130.

The buffer memory 120 may temporarily store data. For example, the buffer memory 120 may temporarily store data provided from the host device 200 or data read from the memory device 110.

In an embodiment, the buffer memory 120 may be a volatile memory which stores data only when power is supplied and in which stored data is lost when the supply of power is interrupted. For example, examples of the buffer memory 120 may include a static random access memory (SRAM) and a dynamic random access memory (DRAM).

The memory controller 130 may control the overall operation of the storage device 100.

In an embodiment, the memory controller 130 may include a processor that runs firmware (FW), a memory that stores the firmware, a host interface that communicates with the host device 200, a memory interface that communicates with the memory device 110, etc.

When power is applied to the storage device 100, the memory controller 130 may run the firmware (FW). When the memory device 110 is a flash memory device, the firmware (FW) may include a host interface layer (HIL) which controls communication with the host device 200, a flash translation layer (FTL) which controls communication between the host device 200 and the memory device 110, and a flash interface layer (FIL) which controls communication with the memory device 110.

In an embodiment, the memory controller 130 may receive data and a logical block address (LBA) from the host device 200, and may translate the logical block address (LBA) into a physical block address (PBA) indicating the address of memory cells which are included in the memory device 110 and in which the data is to be stored. In some embodiments discussed in this patent document, the term “logical block address” can be used to indicate a logical address. In some embodiments discussed in this patent document, the term “physical block address” can be used to indicate a physical address.

In an embodiment, the host device 200 may provide a logical address that is indicated by the location of a write pointer in a zone to which the corresponding logical address belongs. In one example, the logical address provided by the host device 200 may be the starting logical address of an operation corresponding to the request of the host device 200.

In an embodiment, the memory controller 130 may load a portion of the map table stored in the memory device 110 into the buffer memory 120 or the memory included in the memory controller 130. The memory controller 130 may translate the logical address provided from the host device 200 into a physical address mapped to the corresponding logical address based on the loaded map table. Further, the memory controller 130 may update the map table by mapping the physical address to the logical address provided from the host device 200.

In an embodiment, the memory controller 130 may control the memory device 110 so that a write operation, a read operation or an erase operation is performed in response to the request of the host device 200. For example, the memory controller 130 may provide an internal command, an address, and data required to perform the write operation, the read operation or the erase operation to the memory device 110.

The host device 200 may control the overall operation of the computing system 10. In some embodiments discussed in this patent document, the host device 200 communicates with the storage device 100 through a UFS communication method.

In an embodiment, the host device 200 may generate a command CMD corresponding to an input/output request, and may transmit the generated command CMD to the storage device 100. Here, the input/output request may include a write request, a read request or an erase request.

In an embodiment, the host device 200 may generate a command CMD including information for requesting operations. For example, the host device 200 may generate a command CMD including a first information portion INFO1 for requesting a first operation and a second information portion INFO2 related to at least one of second operations or at least part of a second operation to be requested after the first operation is requested, and may output the generated command CMD including the first information portion INFO1 and the second information portion INFO. In some implementations, the host device may transmit the command CMD including the first information portion INFO1 for requesting the first operation and the second information portion INFO2 for requesting part of the second operation that is the subsequent operation of the first operation. In one example, the second information portion INFO2 related to the second operation may include part of information for requesting the second operation. Here, when part of each of a plurality of second operations is requested, the command CMD may include a plurality of second information portions INFO2 related to the plurality of second operations, respectively.

In some implementations, the first operation and the second operation may be operations of the same type or different types.

In an embodiment, the storage device 100 may receive the command CMD from the host device 200, and may perform the first operation based on the first information portion INFO1 for requesting the first operation in response to the command CMD. Furthermore, the storage device 100 may perform part of the at least one second operation based on the second information portion INFO2 related to the at least one second operation included in the command CMD.

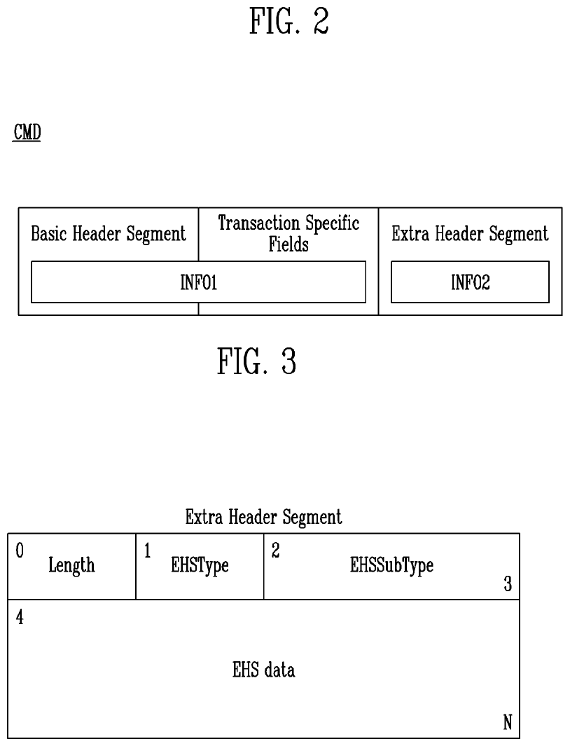

FIG. 2 is a diagram illustrating a command that is transmitted and received between a host device and a storage device based on an embodiment of the disclosed technology.

In an embodiment, the command CMD may be a command that is defined based on a small computer system interface (SCSI) standard. In another embodiment, the command CMD may be a command that is defined based on a UFS standard. For example, the command CMD may be composed of protocol information units (PIUs). The PIUs may include a command PIU, a response PIU, a data out PIU, a data in PIU, a ready to transfer PIU, a mode sense PIU, a mode select PIU, a read buffer PIU, a write buffer PIU, etc. depending on the operation desired to be performed by the host device 200 or the storage device 100.

As shown in FIG. 2, the command CMD implemented using the command PIU. In an embodiment, the host device 200 may transmit the command CMD including a first information portion INFO1 for requesting a first operation and a second information portion INFO2 related to a second operation through the command PIU.

Referring to FIG. 2, the command CMD may include a basic header segment, transaction specific fields, and an extra header segment (EHS).

The basic header segment may include information that is used to enable the host device 200 or the storage device 100 to determine whether a target and a source, a function request, or extra data, and a parameter are required, and/or whether the extra data and the parameter are included in the command CMD, etc.

For example, the basic header segment may include a transaction type, flags, a logical unit number (LUN), a task tag, host device identification information, a command set type, the overall EHS length, etc.

The transaction type may be information that is used to define the usage of the data structure of the command CMD.

The flags may indicate the type of operation intended to be requested through the command CMD.

The LUN may represent a number for identifying the logical unit by which the host device 200 accesses the storage device 100. Here, the logical unit may represent a storage area that is addressable within the storage device. For example, the logical unit may represent at least one of a page, a memory block, a memory block group, a zone, a plane, or a die.

The task tag may represent information for identifying a request corresponding to the command CMD.

The command set type may represent the type of a command included in a command descriptor block (CDB).

The overall EHS length may represent the length of the extra header segment.

The transaction specific fields may include a data transmission length, a command descriptor block (CDB), etc.

The data transmission length may indicate the length of data to be transmitted from the host device 200 to the storage device 100 or from the storage device 100 to the host device 200 in response to a request of the command CMD. Here, the data transmission length may correspond to the length of a logical address.

The command descriptor block (CDB) may include information about various commands and addresses depending on the type of the CDB. For example, the CDB may include a logical address corresponding to the command CMD.

In an embodiment, the host device 200 may include the first information portion INFO1 for requesting the first operation in the basic header segment and the transaction specific fields.

When the basic header segment does not have enough space to store data, the extra header segment may be used to additionally store at least part of the data.

In an embodiment, the host device 200 may include the second information portion INFO2 related to the second operation in the extra header segment.

Although FIG. 2 shows that the host device 200 transmits the command CMD including both the information for requesting the first operation and the information related to the second operation through the command PIU, the disclosed technology is not limited thereto. For example, the host device 200 may transmit the command CMD including both the information for requesting the first operation and the information related to the second operation through another type of PIU.

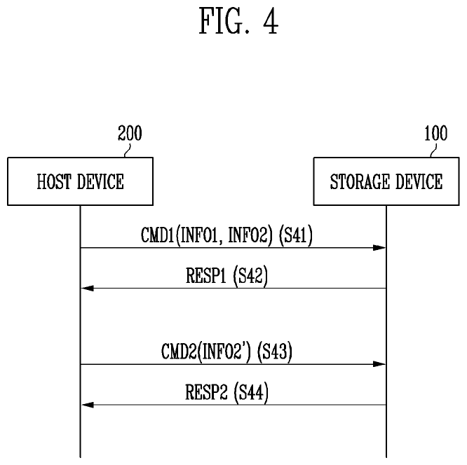

FIG. 3 is a diagram illustrating an extra header segment based on an embodiment of the disclosed technology.

Referring to FIG. 3, the extra header segment may include a length field (Length), an EHS type field (EHSType), an EHS sub-type field (EHSSubType), and an EHS data field (EHS data).

The 0-th byte (0) of the extra header segment may be the length field. The length field (Length) may be a field having the total length of the extra header segment. In an embodiment, N may be ‘32*L−1’. L may be a value stored in the length field.

The first byte of the extra header segment may correspond to the EHS type field (EHSType). The EHS type field (EHSType) may designate the type of the extra header segment. In an embodiment, the host device 200 may store a specific value, indicating that the corresponding data is a type for requesting part of the second operation, in the EHS type field (EHSType). In this case, the storage device 100 may recognize that pieces of data included in the header segment are pieces of information for requesting part of the second operation through the EHS type field (EHSType).

The second and third bytes (2 and 3) of the extra header segment may correspond to the EHS sub-type field (EHSSub Type).

The fourth to N-th bytes (4 to N) of the extra header segment may correspond to the EHS data field (EHS data). The EHS data field (EHS data) may include the information related to the second operation.

In an embodiment, the EHS data field (EHS data) may include flags related to the second operation, the LUN, the task tag, the host device identification information, the data transmission length, the logical address, various types of other CDBs, etc. For example, the host device 200 may include flags, indicating the type of the second operation such as a read operation or a write operation, in the EHS data field (EHS data). Further, the host device 200 may include a LUN intended to be accessed for the second operation in the EHS data field (EHS data). Furthermore, the host device 200 may include a task tag for identifying a request corresponding to the second operation in the EHS data field (EHS data). Furthermore, the host device 200 may include the identification information of the host device 200 in the EHS data field (EHS data). Furthermore, the host device 200 may include a data transmission length, indicating the length of data desired to be read during a read operation or the length of data desired to be stored during a write operation, in the EHS data field (EHS data). Furthermore, the host device 200 may include a logical address, indicating the location at which the second operation is to be performed, in the EHS data field (EHS data).

In some implementations, when there are a plurality of second operations, a plurality of extra header segments may be generated.

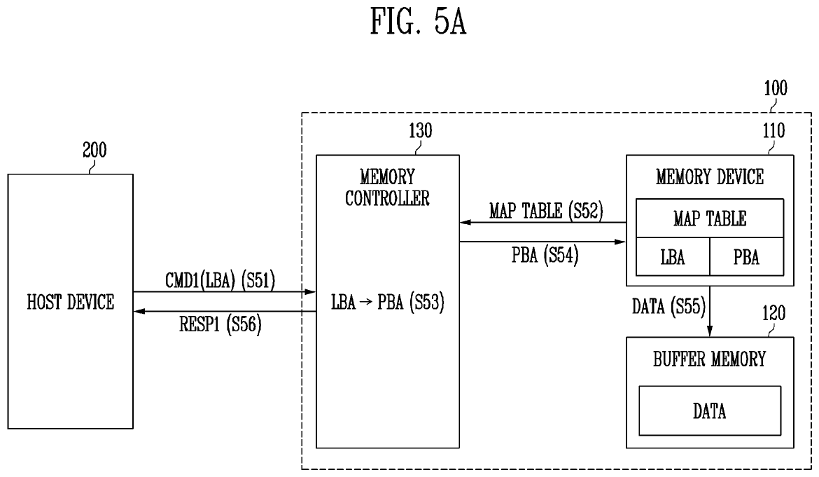

FIG. 4 is a flow diagram illustrating an example of performing part of a second operation to be requested after performing a first operation based on an embodiment of the disclosed technology. FIG. 4 is a diagram illustrating the case where there is one subsequent operation for the first operation.

Referring to FIG. 4, at S41, the host device 200 may transmit a first command CMD1, including the first information portion INFO1 for requesting the first operation and the second information portion INFO2 related to the second operation, to the storage device 100.

At S42, the storage device 100 may perform the first operation and part of the second operation, and then transmit a response RESP1 to the first command CMD1 to the host device 200. The response RESP1 may be a signal indicating that the first command CMD1 has been processed and/or has been executed, and may be implemented using a response PIU.

At S43, the host device 200 may transmit a second command CMD2 including an additional second information portion INFO2′ for requesting the second operation to the storage device 100. For example, the additional second information portion INFO2′ may be used to request the remaining second operation.

At S44, the storage device 100 may perform the remaining operation other than the part of the second operation already performed, and then transmit a response RESP2 to the second command CMD2 to the host device 200. In this case, because the part of the second operation has been performed in advance in response to the first command CMD1, the time it takes for the storage device 100 to process or execute the second command CMD2 may be reduced.

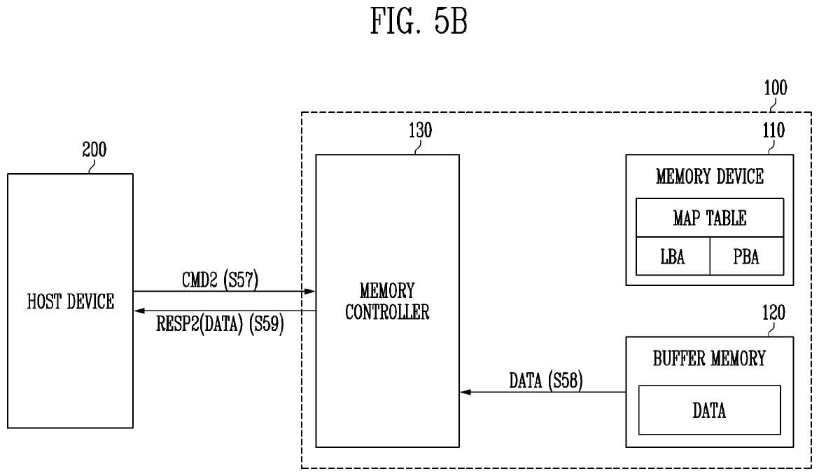

FIGS. 5A and 5B are diagrams illustrating an example of performing a read operation to be requested after performing a first operation based on an embodiment of the disclosed technology. FIGS. 5A and 5B are diagrams illustrating the implementation of individual operations illustrated in FIG. 4 when the second operation is a read operation. In some implementations, as shown in FIG. 5A, part of the second operation is performed, and as shown in FIG. 5B, the remaining operation other than the part of the second operation is performed.

Referring to FIGS. 4 and 5A, at S51, the host device 200 may transmit a first command CMD1, including the first information portion INFO1 for requesting the first operation and the second information portion INFO2 related to the second operation, to the memory controller 130. Here, the second information portion INFO2 related to the second operation may include a logical address (LBA) corresponding to the second operation.

After the first operation is performed based on the first information portion INFO1 for requesting the first operation, the memory controller 130 may obtain a portion of a map table from the memory device 110 at S52.

At S53, the memory controller 130 may obtain a physical address (PBA) mapped to the logical address (LBA) corresponding to the second operation from the map table based on the second information portion INFO2 related to the second operation. For example, the memory controller 130 may obtain the logical address (LBA) corresponding to the second operation from the second information portion INFO2 related to the second operation. The memory controller 130 may translate the logical address (LBA) corresponding to the second operation into the physical address (PBA) based on the map table. Further, when the second operation corresponds to a sequential read request, the memory controller 130 may identify a target zone for the second operation based on zone identification information, and may obtain the location information of a write pointer in the target zone based on the map table.

At S54, the memory controller 130 may provide the physical address (PBA), together with a read command, to the memory device 110.

At S55, the storage device 100 may read data DATA corresponding to the second operation from the memory device 110 based on the obtained physical address (PBA), and may store the read data in the buffer memory 120.

At S56, the memory controller 130 may transmit a response RESP1 corresponding to the first command CMD1 to the host device 200.

Referring to FIGS. 4 and 5B, at S57, the host device 200 may transmit a second command CMD2 including an additional second information portion INFO2′ for requesting the second operation to the memory controller 130.

At S58, the memory controller 130 may obtain data DATA corresponding to the second operation from the buffer memory 120.

At S59, the memory controller 130 may transmit a response RESP2 corresponding to the second command CMD2 to the host device 200. Here, the response RESP2 may include data DATA corresponding to the second operation.

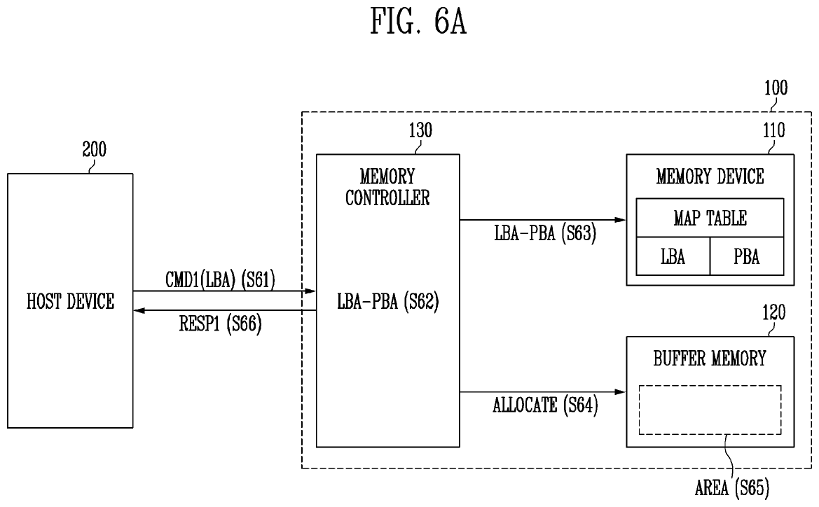

FIGS. 6A and 6B are diagrams illustrating an example of performing a write operation to be requested after performing a first operation based on an embodiment of the disclosed technology. FIGS. 6A and 6B illustrate the implementation of individual operations illustrated in FIG. 4 when the second operation is a write operation. In some implementations, as shown in FIG. 6A, part of the second operation is performed, and as shown in FIG. 6B, the remaining operation other than the part of the second operation is performed.

Referring to FIGS. 4 and 6A, at S61, the host device 200 may transmit a first command CMD1, including the first information portion INFO1 for requesting the first operation and the second information portion INFO2 related to the second operation, to the memory controller 130. Here, the second information portion INFO2 related to the second operation may include a logical address (LBA) corresponding to the second operation.

After the first operation is performed based on the first information portion INFO1 for requesting the first operation, the memory controller 130 may update the map table by mapping the physical address (PBA) to the logical address (LBA) corresponding to the second operation at S62. When the second operation corresponds to a sequential write request, the memory controller 130 may identify a target zone for the second operation based on zone identification information, and may update write pointer location information corresponding to the second operation in the map table.

At S63, the memory controller 130 may transmit mapping information LBA-PBA between the logical address (LBA) and the physical address (PBA) to the memory device 110.

At S64, the memory controller 130 may control the buffer memory 120 to allocate a buffer area AREA in which data corresponding to the second operation is to be temporarily stored in the buffer memory 120.

At S65, the buffer memory 120 may allocate the buffer area AREA under the control of the memory controller 130.

At S66, the memory controller 130 may transmit a response RESP1 corresponding to the first command CMD1 to the host device 200.

Referring to FIGS. 4 and 6B, at S67, the host device 200 may transmit a second command CMD2 including an additional second information portion INFO2′ for requesting the second operation to the memory controller 130. Here, the second command may include write data DATA corresponding to the second command CMD2.

At S68, the memory controller 130 may control the buffer memory 120 to store the write data DATA in the pre-allocated area AREA in the buffer memory 120.

At S69, the memory controller 130 may transmit a response RESP2 corresponding to the second command CMD2 to the host device 200.

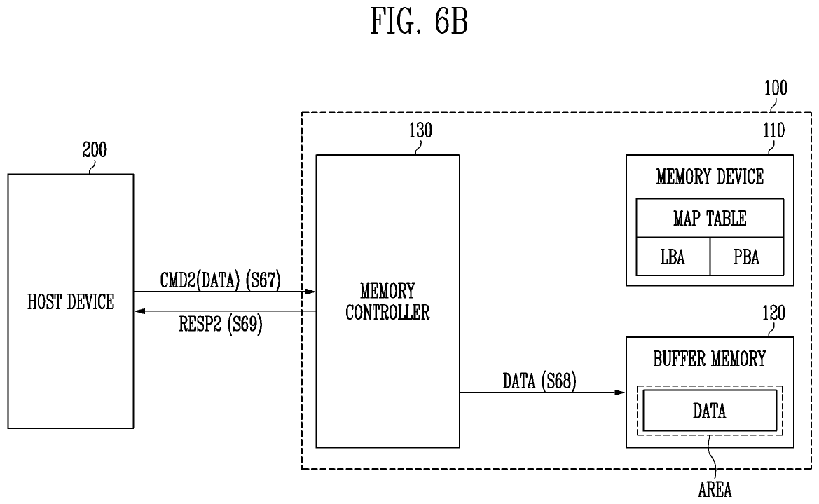

FIG. 7 is a diagram illustrating an example of providing error information to a host device based on an embodiment of the disclosed technology.

Referring to FIGS. 4 and 7, at S71, the host device 200 may transmit a first command CMD1, including the first information portion INFO1 for requesting the first operation and the second information portion INFO2 related to the second operation, to the memory controller 130.

After the first operation is performed based on the first information portion INFO1 for requesting the first operation, the storage device 100 may determine whether an error is expected to occur during the second operation based on the second information portion INFO2 related to the second operation. When it is determined that an error is expected to occur, the storage device 100 may transmit information about the error to the host device 200.

For example, at S72, the storage device 100 may detect an error based on the second information portion INFO2 related to the second operation.

Here, when data is erroneous or invalid, e.g., when flags, a LUN, a task tag, host device identification information, data transmission length, and a logical address, which are included in the second information portion INFO2 related to the second operation are erroneous or invalid, the storage device 100 may detect errors. Further, when a read fail occurs while part of the second operation is being performed, the storage device 100 may detect an error.

At S73, the memory controller 100 may transmit a response RESP1 corresponding to the first command CMD1 to the host device 200. Here, the response RESP1 may include information about the error. Thereafter, in an embodiment, the host device 200 may correct erroneous data included in the second information portion INFO2 related to the second operation based on the information about the error, and may transmit an additional second information portion INFO2′ for requesting the second operation, including the corrected data, to the storage device 100 when requesting the second operation.

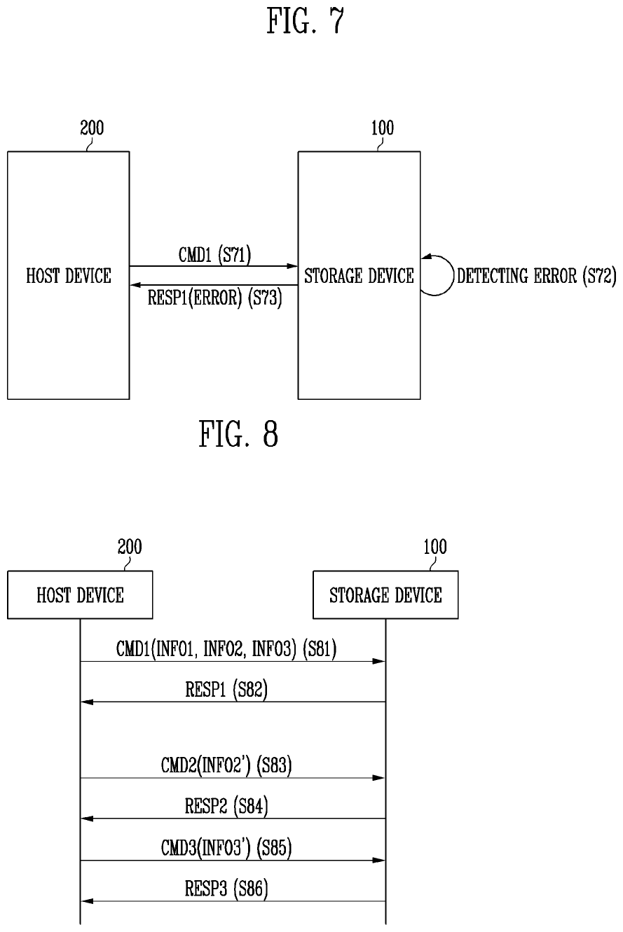

FIG. 8 is a flow diagram illustrating an example of performing part of each of a plurality of second operations to be requested after performing a first operation based on an embodiment of the disclosed technology. FIG. 8 is a diagram illustrating the case where there are a plurality of subsequent operations for the first operation. Hereinafter, a description will be made on the assumption that a first operation, a second operation, and a third operation are sequentially performed.

Referring to FIG. 8, at S81, the host device 200 may transmit a first command CMD1 including first information portion INFO1 for requesting the first operation, a second information portion INFO2 related to the second operation, and information INFO3 related to the third operation to the storage device 100.

At S82, the storage device 100 may perform the first operation, part of the second operation, and part of the third operation, and then transmit a response RESP1 to the first command CMD1 to the host device 200.

Thereafter, the host device 200 may generate a plurality of commands for requesting a plurality of subsequent operations, respectively, and may sequentially transmit the plurality of commands to the storage device 100. In addition, the storage device 100 may sequentially perform the remaining operations, other than parts of respective subsequent operations, among the plurality of subsequent operations in response to the plurality of commands.

At S83, the host device 200 may transmit a second command CMD2 including an additional second information portion INFO2′ for requesting the second operation to the storage device 100. For example, the additional second information portion INFO2′ may be used to request the remaining second operation.

At S84, the storage device 100 may perform the remaining operation other than the part of the second operation, and then transmit a response RESP2 to the second command CMD2 to the host device 200. In this case, because the part of the second operation has been performed in advance in response to the first command CMD1, the time it take for the storage device 100 to process or execute the second command CMD2 may be reduced.

At S85, the host device 200 may transmit a third command CMD3 including information INFO3′ for requesting the third operation to the storage device 100.

At S86, the storage device 100 may perform the remaining operation other than the part of the third operation, and then transmit a response RESP3 to the third command CMD3 to the host device 200. In this case, because the part of the third operation has been performed in advance in response to the first command CMD1, the time required by the storage device 100 to process the third command CMD3 may be reduced.

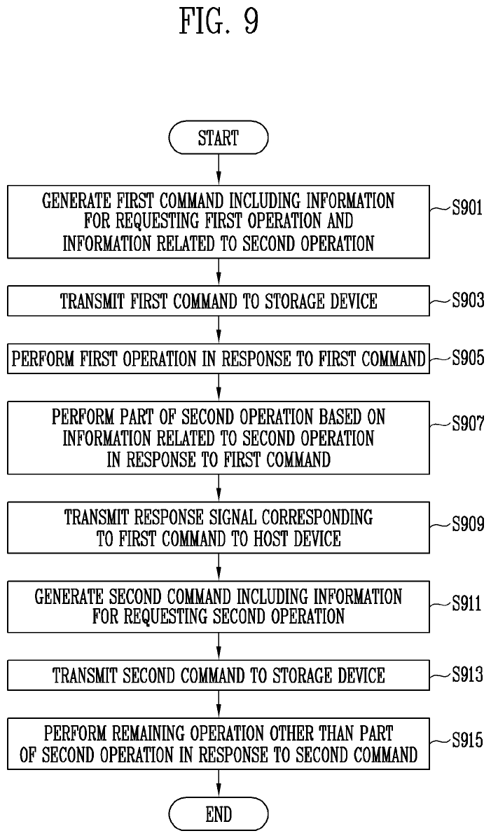

FIG. 9 is a flowchart illustrating a method of operating a computing system based on an embodiment of the disclosed technology. The method illustrated in FIG. 9 may be performed by, for example, the computing system 10 illustrated in FIG. 1.

Referring to FIG. 9, at S901, the computing system 10 may generate a first command including information for requesting a first operation and information related to a second operation to be requested after the first operation. For example, the computing system 10 may include the information related to the second operation in an extra header segment included in the first command.

At S903, the computing system 10 may transmit the first command to the storage device 100.

At S905, the computing system 10 may perform the first operation in response to the first command.

At S907, the computing system 10 may perform part of the second operation based on the information related to the second operation in response to the first command.

For example, when the second operation is a read operation, the computing system 10 may translate a logical address corresponding to the second operation into a physical address mapped to the logical address based on the information related to the second operation. Further, the computing system 10 may prefetch data corresponding to the second operation based on the physical address.

In an example, when the second operation is a write operation, the computing system 10 may map a physical address to a logical address corresponding to the second operation. In addition, the computing system 10 may allocate a buffer area in which data corresponding to the second operation is to be temporarily stored.

At S909, the computing system 10 may transmit a response signal corresponding to the first command to the host device 200.

At S911, the computing system 10 may generate a second command including information for requesting the second operation.

At S913, the computing system 10 may transmit the second command to the storage device 100.

At S915, the computing system 10 may perform the remaining operation other than part of the second operation in response to the second command.

In an example, when the second operation is a read operation, the computing system 10 may transmit the prefetched data to the host device 200.

In an example, when the second operation is a write operation, the storage device 100 of the computing system 10 may receive data corresponding to the second operation from the host device 200, and may store the data corresponding to the second operation in the pre-allocated buffer area. Furthermore, when the storage device 100 receives a flush request from the host device 200, the storage device 100 may store the data corresponding to the second operation, stored in the buffer area, in a storage area corresponding to the pre-mapped physical address.

In this way, the command processing speed of a computing system implemented based on some embodiments of the disclosed technology can be improved.

The embodiments and implementations disclosed above are examples only, and thus various enhancements and variations to the disclosed embodiments and implementations and other embodiments and implementations can be made based on what is described and illustrated in this patent document

What is claimed is:

1. A computing system, comprising:
a host device configured to: generate a command including information associated with operations to be requested, the information including a first information portion associated with a first operation of the operations and a second information portion associated with a second operation to be requested subsequent to the first operation; and output the command including the first information portion and the second information portion; and
a storage device configured to store data and in communication with the host device, wherein the storage device is configured to: receive the command from the host device; perform the first operation in response to the command; and perform part of the second operation based on the second information portion in the command.

2. The computing system according to claim 1, wherein:
the command comprises a basic header segment, transaction specific fields, and an extra header segment (EHS); and
the host device is configured to include the first information in the basic header segment and the transaction specific fields and include the second information in the extra header segment.

3. The computing system according to claim 1, wherein the second information portion includes one or more of a logical address corresponding to the second operation, a length of the logical address, a type of the second operation, identification information of a storage area desired to be accessed during the second operation, or identification information of the host device.

4. The computing system according to claim 3, wherein the storage device comprises:
a memory device configured to store a map table including mapping relationships between logical addresses provided from the host device and physical addresses of the memory device; and
a buffer memory configured to temporarily store data provided from the host device or data read from the memory device.

5. The computing system according to claim 4, wherein, in a case that the second operation is a read operation, the storage device obtains a physical address mapped to a logical address corresponding to the second operation from the map table based on the second information portion.

6. The computing system according to claim 5, wherein the storage device is configured to read data corresponding to the second operation from the memory device based on the obtained physical address and store the read data in the buffer memory.

7. The computing system according to claim 4, wherein, in a case that the second operation is a write operation, the storage device updates the map table by mapping a physical address to a logical address corresponding to the second operation.

8. The computing system according to claim 4, wherein, in a case that the second operation is a write operation, the storage device allocates a buffer area in which data corresponding to the second operation is to be temporarily stored in the buffer memory.

9. The computing system according to claim 1, wherein the storage device is configured to perform the first operation and the part of the second operation and then transmit a response to the command to the host device.

10. The computing system according to claim 1, wherein the storage device is configured to: determine whether an error is expected to occur during the second operation based on the second information portion; and transmit information about the error to the host device upon determination that the error is expected to occur.

11. A method of operating a computing system, comprising:
generating, by a host device, a first command including information associated with operations to be requested, the information including a first information portion associated with a first operation and a second information portion associated with a second operation to be requested subsequent to the first operation;
transmitting, by the host device, the first command to a storage device that stores data;
performing, by the storage device, the first operation in response to the first command;
performing, by the storage device, part of the second operation based on the second information portion in response to the first command;
transmitting, by the storage device, a response to the first command to the host device;
generating, by the host device, a second command including the second information portion;
transmitting, by the host device, the second command to the storage device; and
performing, by the storage device, a remaining operation other than the part of the second operation in response to the second command.

12. The method according to claim 11, wherein generating the first command comprises:
inserting the second information portion into an extra header segment (EHS) included in the first command.

13. The method according to claim 11, wherein performing the part of the second operation comprises:
translating a logical address corresponding to the second operation into a physical address mapped to the logical address based on the second information portion in response to the second operation that is a read operation; and
prefetching data corresponding to the second operation based on the physical address.

14. The method according to claim 13, wherein performing the remaining operation comprises:
transmitting the prefetched data to the host device.

15. The method according to claim 11, wherein performing the part of the second operation comprises:
mapping a physical address to a logical address corresponding to the second operation in response to the second operation in a case that the second operation is a write operation; and
allocating a buffer area in which data corresponding to the second operation is temporarily stored.

16. The method according to claim 15, wherein performing the remaining operation comprises:
receiving the data corresponding to the second operation from the host device;
storing the data corresponding to the second operation in the buffer area; and
storing the data corresponding to the second operation, stored in the buffer area, into a storage area corresponding to the physical address in response to a flush request of the host device.

17. A computing system, comprising:
a host device configured to: insert a plurality of second information portions associated with a plurality of second operations into a command for requesting a first operation; and output the command including the plurality of second information portions; and
a storage device coupled in communication with the host device and configured to: receive the command from the host device; perform the first operation in response to the command; and perform respective parts of the plurality of second operations based on the plurality of second information portions in the command.

18. The computing system according to claim 17, wherein the host device is configured to: receive a response to the command from the storage device; generate a plurality of commands for requesting the plurality of second operations, respectively; and sequentially transmit the plurality of commands to the storage device.

19. The computing system according to claim 18, wherein the storage device is configured to sequentially perform remaining operations, other than the respective parts of the plurality of second operations, among the plurality of second operations in response to the plurality of commands.
